(19) United States
(12) Patent Application Publication
(10) Pub. No.: US 2015/0196126 A1
(43) Pub. Date: Jul. 16, 2015

(54) ATTACHABLE CHILD BLANKET AND NURSING COVER

(71) Applicant: ELIZABETH IRENE BOWE, SAN DIEGO, CA (US)

(72) Inventor: ELIZABETH IRENE BOWE, SAN DIEGO, CA (US)

(21) Appl. No.: 14/595,082

(22) Filed: Jan. 12, 2015

Related U.S. Application Data
(60) Provisional application No. 61/928,375, filed on Jan. 16, 2014.

(51) Int. Cl. A47C 7/66; A47D 15/00; B62B 9/14; A41D 1/20

(52) U.S. Cl. CPC A47C 7/66; A41D 1/205; A47D 15/00; B62B 9/142

(57) ABSTRACT

The present invention is directed to an attachable blanket and a nursing cover for a child carrying device such as child car seat, stroller, infant swing, and the like. In particular, the nursing cover provides privacy for a nursing mother. The blanket is light, easy to use, and has adjustable straps for securely attaching the blanket to the carrying device.

### CROSS-REFERENCE TO RELATED APPLICATIONS

This application claims the benefit of U.S. Provisional Application No. 61/928,375, filed on Jan. 16, 2014.

### FIELD OF THE INVENTION

The present invention is directed to a child blanket and nursing cover for use in child/infant carrying devices. More particularly, the present invention relates to an attachable blanket that can be used in any child carrying device such as child/infant car seats, strollers, baby swings, and the like. Furthermore, due to the specific design, the present invention can also be used as a nursing cover for a mother. In addition, the present invention is also directed to a method for using the cover for a nursing mother while nursing an infant.

### BACKGROUND

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

Parents and caregivers of small children usually carry necessary items to comfortably travel outside the home with the child. Two such items are a baby blanket and a nursing cover. Baby blankets that are used to wrap and cover a small child in a carrying device, such as a stroller or car seat, are often displaced by the child due to kicking or slipping off due to gravity and movement of the carrying device, wind or other external factors, resulting in soiled or lost blankets. In addition, nursing mothers need privacy while nursing their infants outside their homes, such as in parks, airports, shopping centers, or other public places. However, the blankets that are used without any attachment to the mother can be easily blown off, or even pulled off from a nursing mother who is trying to nurse the baby without exposing herself or the child to the surrounding environment. Currently, a number of nursing covers exist today, with a single strap from one side to wrap around the mother's neck and connect to the other side by double backing between two D-rings (see, for example, UdderCovers). However, it is difficult to adjust this cover with one hand while holding a child with the other hand. Also, the strap and D-Ring design can slip, negating their purpose. And, having to carry both a baby blanket and a nursing cover adds to the load a caregiver must travel with and increases the chances of losing or damaging such items. There are also infant carrier covers offered, for example, by Kozy Kid Inc., which requires a long zipper to provide access to the child. Furthermore, such covers cannot be used as a nursing cover.

Therefore, there exists a need for a blanket that does not have the aforementioned limitations and provides caregivers a cover for any child carrying device that is easy to use, keeps the child warm, and can also provide a multi-function purpose, such as a nursing cover by providing privacy to a nursing mother while attending to an infant.

### SUMMARY OF THE INVENTION

The present invention is directed to an attachable blanket for covering child carrying devices, and especially relating to blankets that are suitable for use with child seats, strollers, infant carriers, infant swings, and the like. In an embodiment of the present invention, the blanket is used for a carrying device to accommodate an occupant, wherein the occupant comprises an infant, or a child. In another embodiment of the present invention, the blanket is used as a cover for a nursing woman, providing privacy for both the mother and child while the infant child is nursing. In certain embodiments, the invention provides protection for a multiple-occupant carrying device such as a double or triple stroller. A further embodiment of the invention provides a cover that will substantially protect the child from the cold air, sun, wind, rain, natural and environmental elements while being securely attached to the carrying device with adjustable straps.

In another embodiment, the blanket incorporates reflective materials that provide enhanced safety and visibility in the dusk and dark hours.

In an embodiment, the present invention comprises an attachable child blanket configured to be removably fitted to an occupant carrying device, said blanket comprising a plurality of flexible sheets, wherein said sheets form an elongated panel comprising a top surface and a bottom surface; a plurality of adjustable straps, wherein said adjustable straps are configured to attach said blanket to the handle or frame of said carrying device; and a set of edge-fastening devices attached to opposing sides of said adjustable straps.

In another embodiment, the carrying device comprises an infant seat, a child seat, a stroller, an infant swing, or a multiple occupant stroller.

In yet another embodiment, the occupant is an infant, or a child.

In still another embodiment, the flexible sheets further comprise lycra, polyester, cotton-polyester blend, rayon, flannel, fleece, cotton, or any combination thereof.

In another embodiment, the edge-fastening device comprises hook-and loop tape or a set of ties.

In still another embodiment, the edge-fastening devices are a plurality of hook-and loop tapes and said plurality of hook-and-loop tapes further connects said adjustable straps to said carrying device.

In still another embodiment, the hook-and-loop tapes form a circular hole for a nursing mother to put her head through said circular hole, thereby simultaneously providing privacy for said nursing mother and warmth for an infant.

In another embodiment, the plurality of adjustable straps comprise flexible fabric. In yet another embodiment, the blanket protects said occupant from the external environment.

In another embodiment, the blanket comprises air-permeable material, non-air-permeable material, or a combination thereof.

In yet another embodiment, the elongated panel is about 25 to 40 inches long, and about 25 to 40 inches wide.

In still another embodiment, the elongated panel is about 28 inches long and about 28 inches wide.

In another embodiment, the straps are about 4 to 8 inches long and about 0.5 to 2 inches wide.

In yet another embodiment, the straps are about 6 inches long and about 1 inch wide.

In still another embodiment, the present invention comprises a method of providing privacy for a nursing mother comprising using a removably protective cover comprising a plurality of flexible sheets, wherein said sheets form an elongated panel comprising a top surface and a bottom surface; a plurality of adjustable straps, wherein said plurality of adjustable straps are configured to attach said cover to the handle or frame of said carrying device; and a plurality of hook-and-loop tapes attached to opposing sides of said adjustable straps; attaching the male portion of said hook-and-loop tape on one said adjustable strap to the female portion of the corresponding hook-and-loop tape on a second said adjustable strap to form a circular hole; and putting the head of said nursing mother through said circular hole.

In still another embodiment, the circular hole provides privacy for said nursing mother and warmth for an infant.

In yet another embodiment, the attachable child blanket is configured to be removably fitted to an occupant carrying device, said blanket comprising a plurality of flexible sheets, wherein said sheets form an elongated panel comprising a top surface and a bottom surface; a plurality of adjustable straps, wherein said adjustable straps are configured to attach said blanket to the handle or frame of said carrying device; and a plurality of hook-and-loop tapes attached to opposing sides of said adjustable straps.

In another embodiment, the adjustable straps attach said blanket to the handle or frame of said carrying device, thereby providing protection for an occupant from the external environment.

In yet another embodiment, the present invention comprises an attachable child blanket configured to be removably fitted to an occupant carrying device, said blanket comprising a plurality of flexible sheets, wherein said sheets form an elongated panel comprising a top surface and a bottom surface; a plurality of adjustable straps, wherein said adjustable straps are configured to attach said blanket to the handle or frame of said carrying device; a set of edge-fastening devices attached to opposing sides of said adjustable straps; and a plurality of weights, wherein said weights are integrated into the two bottom corners of said elongated panel by sewing, and wherein said weights are selected from fabric weights, drapery weights, and weighted rope, and weigh about 0.5 to 2 ounces.

Various objects, features, aspects and advantages of the inventive subject matter will become more apparent from the following detailed description of exemplary embodiments, along with the accompanying figures in which like numerals represent like components.

### BRIEF DESCRIPTION OF THE DRAWINGS

FIG. 1 is an exemplary configuration of an attachable child blanket according to the present invention, and depicts a flat top view of the blanket with adjustable straps that are located at opposing sides of the top edge of the blanket.

FIG. 2 is an exemplary configuration of an attachable child blanket according to the present invention, and depicts a front angled view of the blanket with adjustable straps that are located at opposing sides of the top edge of the blanket, where the blanket is fitted about a child car seat.

FIG. 3 is an exemplary configuration of an attachable child blanket according to the present invention, and depicts a front angled view of the blanket with adjustable straps that are located at opposing sides of the top edge of the blanket, where the blanket is fitted about a stroller.

FIG. 4 is an exemplary configuration of a nursing cover according to the present invention, depicting a front view of the cover with adjustable straps that are located at opposing sides of the top edge of the cover, thus covering the front of a nursing mother.

FIG. 5 is another exemplary configuration of an attachable child blanket according to the present invention, depicting a flat top view of the blanket with adjustable straps that are located at opposing sides of the top edge of the blanket, and includes weights attached at the bottom corners of the blanket.

### DETAILED DESCRIPTION

A protective device for an occupant carrying device is manufactured such that it protects the occupant substantially from the cold weather, sun, wind, rain, and other environmental elements. As used herein, and unless the context dictates otherwise, the term “protective device” is intended to include both a blanket and a cover. Therefore, the terms “protective device”, “blanket” and “cover” are used interchangeably.

Furthermore, as used herein, and unless the context dictates otherwise, the term “occupant” is intended to include an infant, or a child. In an embodiment of the present invention, the cover is used in multiple types of child carriers, restraints, child seats, infant swings, children transport devices, and multiple occupant strollers (e.g., strollers accommodating more than one child, such as twins or triplets, children of similar ages, or the like).

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used in the description herein and throughout the claims that follow, the terms “use” and “configured” may be used interchangeably.

As used herein, the term “about” in conjunction with a numeral refers to a range of that numeral starting from 10% below the absolute of the numeral to 10% above the absolute of the numeral, inclusive.

The material of construction for the blanket is a flexible fabric that conforms to the shape of the carrying device. For example, the material can be air-permeable so that air can flow through the protective device, such as during warm weather. Alternatively, in another embodiment, the material can be non-air-permeable to insulate the occupant from cold air. Furthermore, the material can be water resistant to protect the occupant during wet conditions, such as rain. Examples of material of construction include lycra, polyester, cotton-polyester blend, rayon, flannel, fleece, cotton, or any combination of the aforementioned materials, including materials of flexible degree, and combinations of materials that are flexible along with relatively less flexible or inflexible materials.

In an embodiment, the cover incorporates one or more reflective materials that provide enhanced safety and visibility in the dusk and dark hours, or during inclement weather such as rain or snow. Furthermore, any decorative design, such as objects, animals, flowers, toys, and the like can be incorporated in the blanket material. A skilled person in the art will be readily able to select a suitable material of construction for the blanket based on the operating conditions and requirements in the configurations contemplated herein.

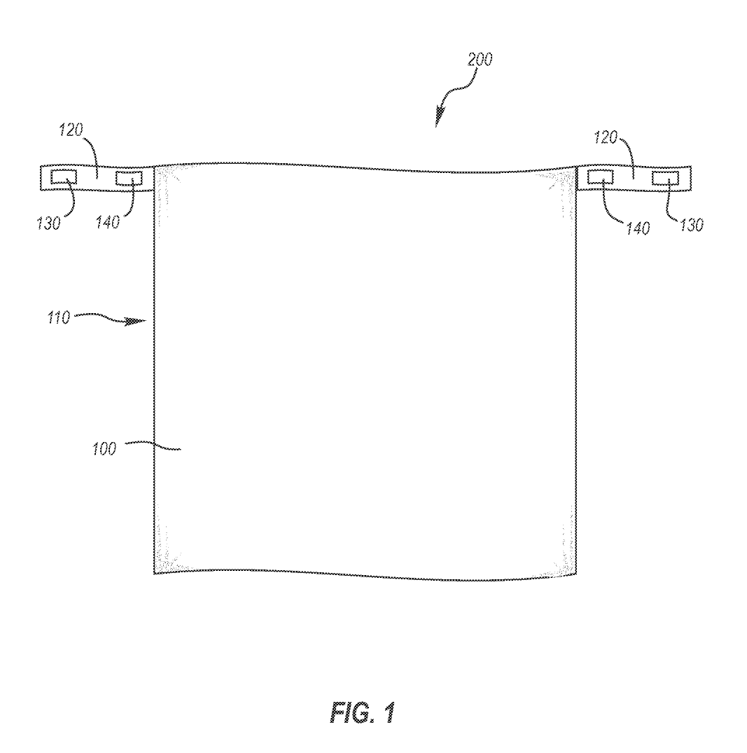

An exemplary configuration is schematically depicted in FIG. 1, in which attachable blanket 200 is configured for use in connection with a child carrying device such as a child car seat, stroller, infant swing, or the like. Attachable blanket 200 includes an elongated panel 110 comprising a top surface 100 that faces the external environment, a bottom surface (not shown) that faces the occupant, a plurality of adjustable straps 120, and a male 130 and female 140 hook-and loop tape which are located on adjustable straps 120. Attachable blanket 200 is manufactured from flexible materials and conforms to the carrying device and protects the occupant from the natural environment.

In another embodiment, both top surface 100 and bottom surface are manufactured from a flexible, air-permeable material to keep the occupant cool during warm conditions by allowing air to flow through the material. In another embodiment, both top surface 100 and bottom surface are manufactured from non-air-permeable and water-resistant material to keep the occupant shielded from cool temperatures, wind, rain and other weather conditions.

In yet another embodiment, attachable blanket 200 incorporates one or more reflective materials that provide enhanced safety and visibility in the dusk and dark hours.

Top surface 100 and bottom surface are attached together by a closing mechanism around the perimeter of elongated panel 110. In one exemplary embodiment, top surface 100 and bottom surface are sewn together along the outer edges as required by appropriate methods that are common in the state of the art.

In one or more embodiments, top surface 100 and bottom surface can be attached together using fabric glue. In one or more embodiments, top surface 100 can also be stitched along entire perimeter of attachable blanket 200 to bottom surface. In an embodiment, top surface 100 and bottom surface may also comprise a single sheet, particularly where made from air permeable material. Attachable blanket 200 is of a size such that it is sufficiently long and wide enough to substantially cover the occupant's body and limbs. For example, in an embodiment, attachable blanket 200 is about 25 to 40 inches long and about 25 to 40 inches wide. In another embodiment, attachable blanket 200 is about 28 inches long and about 28 inches wide. In particular, attachable blanket 200 size is optimized to approximately correspond to the dimensions of the carrying device in order to prevent the blanket from dragging on the floor. Attachable blanket 200 size is also configured to provide proper ventilation for the occupant, so that a minimum amount of the attachable blanket 200 length drapes toward the floor when in place on the carrying device. One of ordinary skill in the art can envision other dimensions which may vary with the type of stroller, child car seat, infant swing, or any such carrying device but which do not detract from the spirit of the invention.

In an exemplary embodiment, attachable blanket 200 fully covers an occupant's lower body. More specifically, attachable blanket 200 covers an occupant's entire body. In one or more embodiments, attachable blanket 200 is manufactured to provide protection for occupant or occupants of the multiple occupant carrying device, such as double or triple strollers. For example, strollers are optionally configured as “double-wide” or “triple-wide”, whereby the size of such double or triple stroller is proportionally larger in several dimensions when compared with a standard stroller. The associated cover of the invention is correspondingly sized to match such optional stroller configurations.

Attachable blanket 200 is removably attached to the carrying device by use of a plurality of adjustable straps 120. In an embodiment, adjustable straps 120 are located at opposing sides of the top edge of elongated panel 110, as shown in FIGS. 1-3. Adjustable straps 120 are attached to attachable blanket 200 by sewing. Other suitable attachment means can also be employed to permanently or removably attach adjustable straps 120 to attachable blanket 200.

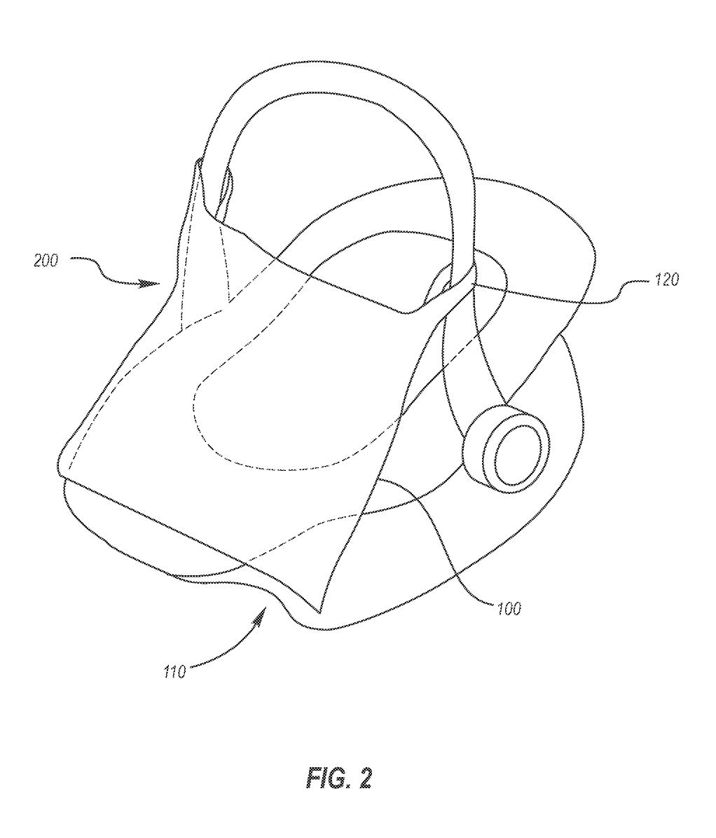

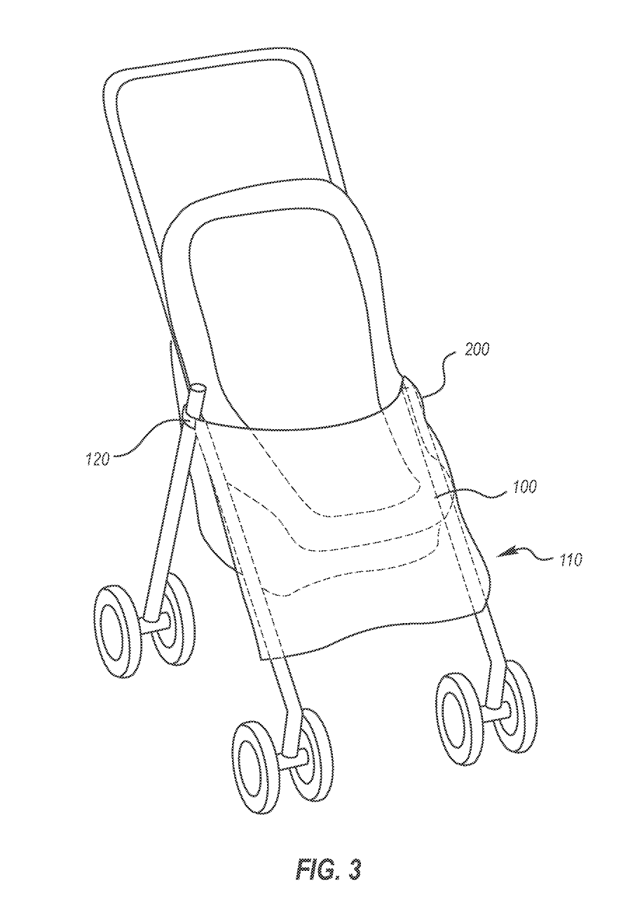

In an embodiment, each of adjustable straps 120 is attached to attachable blanket 200 by a fastening mechanism consisting of a male portion 130 and a female portion 140 of a hook-and loop tape. The hook-and loop tape fastening mechanism enables adjustable straps 120 to be securely attached to the carrying device, as shown in FIGS. 2 and 3. In another exemplary embodiment, male portion 130 and female portion 140 are connected to each other on either side of the handle or the frame of the carrying device to form a loop. In another embodiment, other fastening mechanisms can be employed, such as two sets of ties at the end of each adjustable straps 120. In one or more embodiments, male portion 130 and female portion 140 of hook-and-loop tape may be disposed on the top surface of adjustable straps 120, on the bottom surface of adjustable straps 120, or on any combination of both top and bottom surfaces of adjustable straps 120. One of ordinary skill in the art will readily understand the male portion 130 and female portion 140 of hook-and-loop tape engage together in order to form a closed loop around the carrying device handle or other attachment point to secure the adjustable blanket 200 in place.

In one embodiment, adjustable straps 120 are manufactured from flexible material and employ elongated pieces of hook-and-loop tape, allowing adjustable straps 120 to be adjustable so that adjustable straps 120 are tightly secured around child carriers of varying height and width. In an embodiment, adjustable straps 120 are about 4 to 8 inches long and about 0.5 to 2 inches wide. In another embodiment, adjustable straps 120 are about 6 inches long and about 1 inch wide. One advantage of adjustable strap 120 design is that it allows one to access the carrying device's handle or frame without interfering with the utility of the child carrying device, as shown in FIGS. 2 and 3.

In one or more embodiments, adjustable straps 120 comprise partial hook-and-loop tape that may extend the entire length of each of adjustable strap 120 (not shown), or extend partially toward the end of each adjustable strap 120 (not shown).

FIGS. 2 and 3 depict exemplary embodiments of attachable blanket 200 fitted about a child car seat and a stroller, respectively. Referring to FIG. 2, attachable blanket 200 is placed over the top of a child car seat. As described herein, attachable blanket 200 includes an elongated panel 110 comprising a top surface 100 that faces the external environment, a bottom surface (not shown) that faces the occupant, a plurality of adjustable straps 120, a male portion 130 and female portion 140 of said hook-and loop tape which are located on adjustable straps 120 (not shown). As shown in FIG. 2, adjustable straps 120 attach blanket 200 securely to the handle of the child car seat by employing the hook-and loop tape fastening mechanism, such that male portion 130 and female portion 140 are connected to each other on either side of the handle of the child car seat to form a loop.

Referring to FIG. 3, attachable blanket 200 is placed over the top of a child stroller. As described herein, attachable blanket 200 includes an elongated panel 110 comprising a top surface 100 that faces the external environment, a bottom surface (not shown) that faces the occupant, a plurality of adjustable straps 120, a male portion 130 and female portion 140 of said hook-and loop tape which are located on adjustable straps 120 (not shown). As shown in FIG. 3, adjustable straps 120 attach blanket 200 securely to the frame of the stroller by employing the hook-and loop tape fastening mechanism, such that male portion 130 and female portion 140 are connected to each other on either side of the frame of the child stroller to form a loop. In this manner, attachable blanket 200 serves as a blanket for the child while in a seated position in the stroller.

In one or more embodiments, multiple attachable blankets 200 are utilized to accommodate occupants in double and/or multiple strollers. Due to the specific design of adjustable straps 120, blanket 200 can be adjusted to cover part of the occupant or the entire body of the occupant based on the need of the occupant and the weather condition. Furthermore, blanket 200 can be placed over a child car seat, a stroller, an infant swing, and the like, while the safety belts of the carrying device are in place without dismantling such safety belts or disrupting the occupant.

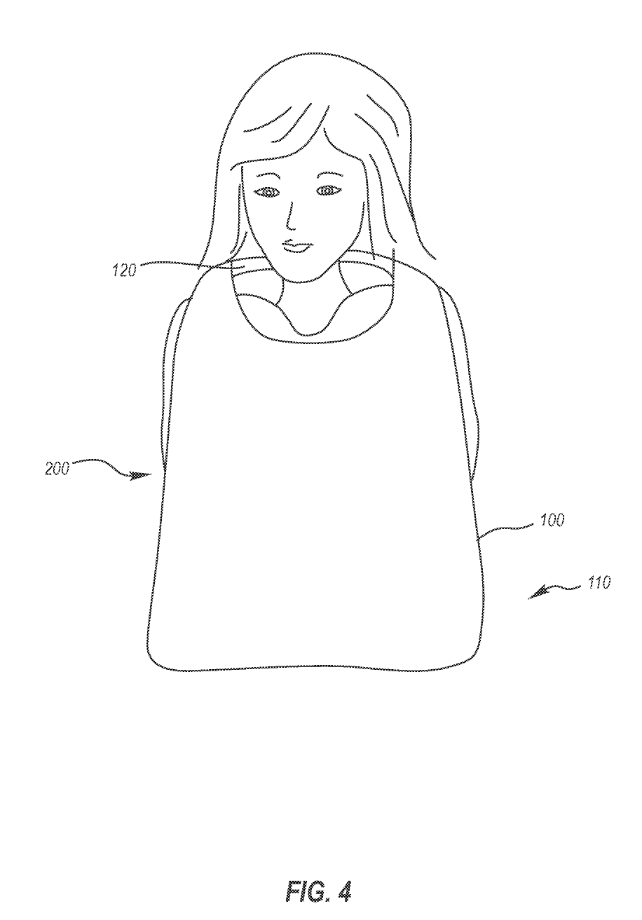

FIG. 4 depicts an embodiment of the present invention wherein attachable blanket 200 is used as a nursing cover. In this embodiment, male portion 130 and female portion 140 of said hook-and loop tape of one adjustable strap 120 is attached to its counterpart on the other adjustable strap 120, located on the opposite side of cover 200, such that a generally circular hole is formed. Accordingly, a nursing mother can place her head through the generally circular hole as depicted in FIG. 4. Cover 200 is then resting around the mother's neck in a manner such that the mother or the child will not have any discomfort or restriction while nursing the child, or even merely covering the child. Cover 200 is draped on the mother's torso to provide privacy for both the mother and the nursing child, while also providing a secure/protective cover for the child from the elements.

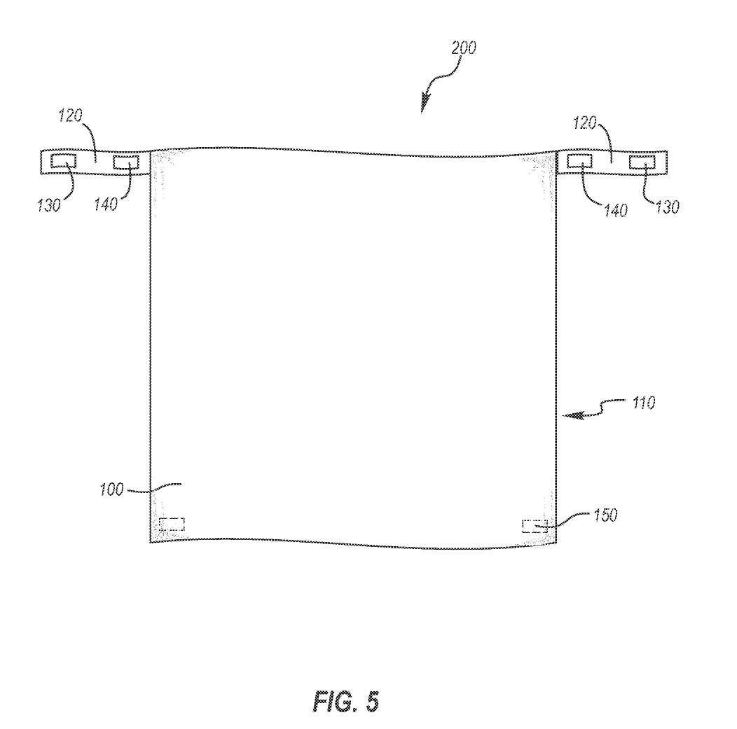

FIG. 5 illustrates another exemplary configuration in which an attachable blanket 200 is configured for use in connection with a child carrying device such as a child car seat, stroller, infant swing, and the like. Attachable blanket 200 includes an elongated panel 110 comprising a top surface 100 that faces the external environment, a bottom surface (not shown) that faces the occupant, a plurality of adjustable straps 120, a male portion 130 and female portion 140 of hook-and loop tape which are located on adjustable straps 120, and optionally a plurality of weights 150. Attachable blanket 200 is manufactured from flexible materials and conforms to the carrying device and protects the occupant from the natural environment.

In a representative embodiment as shown in FIG. 5, blanket 200 includes a plurality of weights 150 located on the bottom corners of blanket 200. Plurality of weights 150 are incorporated in blanket 200 by a suitable attachment mechanism. In an embodiment, weights 150 are secured in place by sewing between top surface 100 and the bottom surface (not shown). In another embodiment, plurality of weights 150 are light weights that provide additional weight to keep blanket 200 in place and furthermore to prevent cover 200 from blowing in the wind. Thus, the occupant, in particular a sleeping baby, will not be disturbed, and blanket 200 will be effective in protecting any occupant from undesirable environmental elements by securing the blanket in place. In yet another embodiment, small pockets are created along the top and the bottom corner of elongated panel 110 such that weights 150 are removably inserted into the small pockets and held in place by hook-and-loop tape or other conventional closing mechanism.

In another embodiment, weights 150 may be located along the bottom edge of blanket 200 such that the weights comprise a strip of interlinked weights, or a length of sequentially spaced and separate weights, or any combination thereof. The user may customize the number and placement of weights along the bottom edge and/or bottom corners of blanket 200 to correspond to use of blanket 200 in relatively strong windy conditions.

Weights 150 are manufactured from steel without any lead and weigh about one ounce each, but may also vary in weight from about 0.2 to 2 ounces each. In certain embodiments, weights 150 are drapery weights, weighing from about 0.5 to 2 ounces each. In an embodiment, plurality of weights 150 are 1 ounce each. In one or more embodiments, plurality of weights 150 are1⅞ inch triangles, weighing from about 0.5 to 1 ounces each. In one or more embodiments, plurality of weights 150 are weighted rope made from 4/32 inch white cotton sausage bead weighted tape, weighing about 1.0 ounce per yard.

Thus, specific embodiments of an attachable blanket for a child carrying device, a nursing cover, and methods to employ such cover have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An attachable child blanket configured to be removably fitted to an occupant carrying device, said blanket comprising:
a) a plurality of flexible sheets, wherein said sheets form an elongated panel comprising a top surface and a bottom surface;
b) a plurality of adjustable straps, wherein said adjustable straps are configured to attach said blanket to the handle or frame of said carrying device; and
c) a set of edge-fastening devices attached to opposing sides of said adjustable straps.

2. The blanket according to claim 1, wherein said carrying device comprises an infant seat, a child seat, a stroller, an infant swing, and a multiple occupant stroller.

3. The blanket according to claim 1, wherein said occupant is an infant or a child.

4. The blanket according to claim 1, wherein said flexible sheets further comprise lycra, polyester, cotton-polyester blend, rayon, flannel, fleece, cotton, or any combination thereof.

5. The blanket according to claim 1, wherein said edge-fastening device comprises hook-and loop tape or a set of ties.

6. The fastening device according to claim 1, wherein said edge-fastening device comprises a plurality of hook-and loop tapes and said plurality of hook-and-loop tapes further connects said adjustable straps to said carrying device.

7. The hook-and loop tapes according to claim 6, wherein said hook-and-loop tapes form a circular hole for a nursing mother to put her head through said circular hole, thereby providing privacy for said nursing mother and warmth for an infant.

8. The blanket according to claim 1, wherein said plurality of adjustable straps comprise flexible fabric.

9. The blanket according to claim 1, wherein said blanket protects said occupant from the external environment.

10. The blanket according to claim 1, wherein said blanket comprises air-permeable material, non-air-permeable material, or a combination thereof.

11. The blanket according to claim 1, wherein said elongated panel is about 25 to 40 inches long, and about 25 to 40 inches wide.

12. The blanket according to claim 1, wherein said elongated panel is about 28 inches long and about 28 inches wide.

13. The blanket according to claim 1, wherein said straps are about 4 to 8 inches long and about 0.5 to 2 inches wide.

14. The blanket according to claim 1, wherein said straps are about 6 inches long and about 1 inch wide.

15. A method of providing privacy for a nursing mother comprising:
a) using a removably protective cover comprising:
i) a plurality of flexible sheets, wherein said sheets form an elongated panel comprising a top surface and a bottom surface;
ii) a plurality of adjustable straps, wherein said plurality of adjustable straps are configured to attach said cover to the handle or frame of said carrying device; and
iii) a plurality of hook-and-loop tapes attached to opposing sides of said adjustable straps;
b) attaching the male portion of said hook-and-loop tape on one said adjustable strap to the female portion of the corresponding hook-and-loop tape on a second said adjustable strap to form a circular hole; and
c) inserting the head of said nursing mother through said circular hole.

16. An attachable child blanket configured to be removably fitted to an occupant carrying device, said blanket comprising:
a) a plurality of flexible sheets, wherein said sheets form an elongated panel comprising a top surface and a bottom surface;
b) a plurality of adjustable straps, wherein said adjustable straps are configured to attach said blanket to the handle or frame of said carrying device; and
c) a plurality of hook-and-loop tapes attached to opposing sides of said adjustable straps.

17. The blanket according to claim 16, wherein said adjustable straps attach said blanket to the handle or frame of said carrying device, thereby providing protection for an occupant from the external environment.

18. The blanket according to claim 16, wherein said carrying device comprise an infant seat, a child seat, a stroller, an infant swing, or a multiple occupant stroller.

19. An attachable child blanket configured to be removably fitted to an occupant carrying device, said blanket comprising:
a) a plurality of flexible sheets, wherein said sheets form an elongated panel comprising a top surface and a bottom surface;
b) a plurality of adjustable straps, wherein said adjustable straps are configured to attach said blanket to the handle or frame of said carrying device;
c) a set of edge-fastening devices attached at opposing sides of said adjustable straps; and
d) a plurality of weights, wherein said weights are integrated into the two bottom corners of said elongated panel, and wherein said weights are selected from fabric weights, drapery weights, and weighted rope and weigh about 0.5 to 2 ounces each.

20. The fastening device according to claim 19, wherein said fastening device comprises a plurality of hook-and loop tapes and said plurality of hook-and-loop tapes further connects said adjustable straps to said carrying device.
